(19) United States
(12) Patent Application Publication
(10) Pub. No.: US 2025/0269337 A1
(43) Pub. Date: Aug. 28, 2025

(54) FLUID MIXING SYSTEMS AND METHODS

(71) Applicant: Life Technologies Corporation, Carlsbad, CA (US)

(72) Inventors: Trevor N. Naumann, Nibley, UT (US); BoDee B. Hancock, Nibley, UT (US); Jacob G. Accordino, Logan, UT (US); Addison J. Litton, Logan, UT (US); Nephi Jones, Newton, UT (US)

(21) Appl. No.: 19/066,059

(22) Filed: Feb. 27, 2025

Related U.S. Application Data
(60) Provisional application No. 63/558,515, filed on Feb. 27, 2024.
(60) Provisional application No. 63/570,993, filed on Mar. 28, 2024.

(51) Int. Cl. B01F 27/113; B01F 27/213; B01F 101/23

(52) U.S. Cl. CPC B01F 27/113; B01F 27/213; B01F 2101/23

(57) ABSTRACT

The present invention relates to a mixing apparatus for use in a fluid mixing equipment. In an embodiment, the mixing apparatus includes a hub having a top portion and a bottom portion and a central opening extending between the top and bottom portions along a centerline. A base flange extends outward from the bottom portion of the hub and one or more blades are coupled to the hub and extending to a shroud wall surrounding at least a portion of the top portion of the hub.

### CROSS-REFERENCE TO RELATED APPLICATIONS

This application claims the benefit of the U.S. Provisional Patent Application Ser. No. 63/570,993 filed Mar. 28, 2024, titled “FLUID MIXING SYSTEMS AND METHODS,” and U.S. Provisional Patent Application Ser. No. 63/558,515, filed Feb. 27, 2024, titled “SYSTEMS AND METHODS FOR FLUID MIXING ASSEMBLIES, which are incorporated herein by specific reference.

### FIELD

The present disclosure relates to fluid mixing systems and methods. More specifically, it is directed to biological fluid mixing systems and methods, including mixing assemblies configured for efficient agitation of microcarrier cell cultures in bioprocessing equipment.

### BACKGROUND OF THE INVENTION

Achieving a high cell density of cells is a prerequisite for different biological and medical applications such as cell therapy, tissue engineering, and vaccine production. Anchorage-dependent or microcarrier-based cell culture has proven to be a promising method for this purpose, mainly due to a high surface area-to-volume ratio. A typical microcarrier-based cell culture process includes three main steps: cell adhesion, cell proliferation, and cell detachment. While adhesion and detachment of cells from microcarriers are two critical stages influencing the quality and efficiency of final cell harvesting, maintaining a uniform cell culture suspension during the proliferation stage of the culturing process is key for increasing harvesting yields. Hence, adequate stirring is essential to maintain the particles in suspension and prevent settling, as a complete suspension would maximize the surface area of contact between the cells and the fluid for efficient mass transfer processes. Most mixing assemblies must be agitated at high revolutions per minute (rpm) to obtain good mixing and maintain a uniform cell culture suspension. Agitation at high rpm causes excessive shear and reduces the size of Kolmogorov eddies, harming shear-sensitive cell lines and decreasing harvest yields. Such situations call for mixing assemblies that can agitate the cell culture with minimal shear by optimizing the agitating mechanism, the agitator and container geometries, and mixing speeds to maintain a uniform suspension.

Accordingly, what is needed in the art are efficient fluid mixing systems and methods for low shear agitation of microcarrier cell cultures in bioprocessing equipment that solve all or some of the above-identified shortcomings or other deficiencies known in the art.

### SUMMARY OF THE DISCLOSURE

It is understood that each independent aspect recited herein may include any of the features, options, and possibilities recited in association with the other independent aspects set forth above or as recited elsewhere within this document.

Example systems and methods for mixing fluids in bioprocessing equipment are disclosed herein. In general, fluid can comprise cell cultures, including microcarriers. Example systems for mixing fluids include a mixing apparatus, including a hub having a top portion and a bottom portion and a central opening extending between the top and bottom portions along a centerline. A base flange extends outward from the bottom portion of the hub, and one or more blades can be coupled to the hub and extended to a shroud wall surrounding at least a portion of the top portion of the hub. The shroud wall can be vertically spaced apart from the base flange. Each blade can be planar and aligned at an angle of 30-70 degrees with the centerline. Further, each blade can include at least one curved edge and one straight edge or have a quadrilateral shape with at least one rounded corner.

In various embodiments, systems for mixing fluids include a mixing apparatus for use in a bioreactor, biofermentor or biomixer. The mixing apparatus includes a hub having a top portion and a bottom portion; a central opening extending between the top and bottom portions along a centerline; a base flange extending outward from the bottom portion of the hub; one or more blades coupled to the hub, wherein at least a first portion of each of the blades is attached to a shroud wall spaced apart, coaxial, and surrounding at least a portion of the top portion of the hub, and at least a second portion of each of the blades is attached to the base flange.

In various embodiments, systems for mixing fluids include a mixing apparatus for use in a bioreactor, biofermentor or biomixer. The mixing apparatus includes a hub having a central opening extending between a top portion and a bottom portion; one or more blades coupled to the hub, each of the blades comprising: a first side, and a portion of the first side coupled to an exterior surface of the hub; a second side opposite to the first side, and at least a portion of the second side coupled to a shroud wall coaxial and surrounding the top portion of the hub; and a third side extending between the first and second sides, and at least a portion of the third side is coupled to a base flange extending from the exterior surface of the hub.

In various embodiments, a fluid mixing system is provided that includes a flexible bag having a first end, an opposing second end, and an interior surface bounding a compartment. A first impeller can be disposed inside the compartment and coupled rotationally to the first end or the second end of the flexible bag. The first impeller can be configured to receive a fluid in an axial direction into an interior space of the first impeller and distribute the fluid radially towards the interior surface of the compartment upon rotation of the impeller. The system can further include an elongated member coupled between the first end of the container and the first impeller and the elongated member can be a drive shaft. The system further includes a second impeller coupled to the elongated member, and the second impeller can be spaced apart from the first impeller.

In the above embodiment, the first impeller includes a hub having a top portion and a bottom portion, a central opening extending between the top and bottom portions along a centerline; a base flange extending outward from the bottom portion of the hub; and a plurality of blades coupled to the hub, and extending to a shroud wall surrounding the top portion of the hub. The plurality of blades can include at least two blades or six blades. The fluid mixing system, can further include a flexible drive line coupled between the first end of the container and a top portion of the first impeller, and a bottom portion of the first impeller being coupled to the second end of the container. The flexible drive line can be a single continuous driveline or a first drive line spaced apart from a second drive line by a plurality of rungs and the impeller can have a turbine shape.

In the above embodiment, the fluid mixing system can include microcarriers and cells and the first impeller can be configured to stir the fluid to provide a homogenous suspension of the microcarriers and cells. The container can have a volume of 50 L and the first impeller can be rotated at an rpm ranging between 30-40 rpm in a working volume of at least 7.5 L of the fluid. The container can have a volume of 7.5 L, 12.5 L, 50 L, or 500 L. The fluid can include microcarriers and cells and the first impeller can be configured to minimize damage to the cells and can be configured to avoid formation of one or more stagnation zones in the fluid.

In various embodiments, a method for mixing a fluid is provided, including inserting a container assembly into a chamber of a support housing. The container assembly can include a container having a first end, an opposing second end, and an interior surface bounding a compartment. A first impeller can be disposed within the compartment of the container and coupled rotationally to the first end or the second end of the container, wherein the first impeller is configured to receive the fluid in an axial direction into an interior space of the first impeller and distribute the fluid radially towards the interior surface of the compartment. The first impeller can be rotated within the flexible bag to mix the fluid.

In the above embodiment, the first impeller can have a turbine shape. The fluid can include one or more human cells, microorganisms, bacteria, fungi, algae, plant cells, animal cells, protozoans, nematodes, and microcarriers. The container can include one or more of a bioreactor, a flexible bag, a condenser, a fermenter, or a mixing chamber. The first impeller can be coupled to the first end of the container by a driveline, including a first driveline and a second driveline, with the first driveline being spaced apart from the second driveline by a plurality of rungs. A second impeller can be coupled to the driveline and the second impeller can be spaced apart from the first impeller. Alternatively, an elongated member can be coupled between the first end of the container and the first impeller. Further, a second impeller can be coupled to the elongated member before rotating the elongated member within the container. The second impeller can be spaced apart from the first impeller. Further, rotation of the elongated member within the container causes both the first and second impellers to rotate, and rotation of the elongated member can be actuated by a drive motor assembly coupled to the container. Further, the container can be flexible.

In various embodiments, an automated bioprocessing system is provided that includes a system controller comprising a processor and memory for storing operational instructions and controlling components of the bioprocessing system. The bioprocessing system can include a first rotary motor coupled with a first end or second end of a container. A first sensor can be coupled to the container which can be in electronic communication with the system controller. A first impeller can be disposed within a compartment of the container and coupled rotationally to the first rotary motor, wherein the first impeller is configured to receive a fluid in an axial direction into an interior space of the first impeller and distribute the fluid radially towards an interior surface of the compartment. A first set of instructions stored in the memory for mixing the fluid. The first sensor can be a cell density sensor configured to provide a signal based on a cell density of the fluid in the container. Further, the system controller can be configured to control operation of the first rotary motor and the first impeller based on the signal provided by the cell density sensor.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 illustrates a fluid mixing system in accordance with example embodiments.

FIG. 2 illustrates a fluid mixing system in accordance with example embodiments.

FIG. 3A illustrates a perspective view of a mixing apparatus in accordance with example embodiments.

FIG. 3B illustrates a top view of the mixing apparatus in accordance with example embodiments.

FIG. 3C illustrates a cross-sectional view of the mixing apparatus in accordance with example embodiments.

FIG. 3D illustrates a side view of the mixing apparatus in accordance with example embodiments.

FIG. 4A illustrates a perspective view of a cap for the mixing apparatus in accordance with example embodiments.

FIG. 4B illustrates a top view of a cap for the mixing apparatus in accordance with example embodiments.

FIG. 4C illustrates a cross-sectional view of a cap for the mixing apparatus in accordance with example embodiments.

FIG. 4D illustrates a side view of a cap for the mixing apparatus in accordance with example embodiments.

FIG. 5A illustrates a perspective view of a mixing assembly in accordance with example embodiments.

FIG. 5B illustrates an exploded view of the mixing assembly in accordance with example embodiments.

FIG. 6A illustrates a perspective view of a mixing assembly in accordance with one embodiment.

FIG. 6B illustrates an exploded view of the mixing assembly in accordance with example embodiments.

FIG. 7A illustrates a perspective view of a mixing assembly in accordance with example embodiments.

FIG. 7B illustrates a front view of the mixing assembly in accordance with example embodiments.

FIG. 8A illustrates a fluid mixing system in accordance with example embodiments.

FIG. 8B illustrates a fluid mixing apparatus in accordance with example embodiments.

FIG. 8C illustrates a fluid mixing apparatus in accordance with example embodiments.

FIG. 9 is a block diagram of an automated bioprocessing system, including a fluid mixing system in accordance with example embodiments.

FIG. 10 is a block diagram of an example computing device that can automate all operations of an example fluid processing system, including a fluid mixing assembly.

FIG. 11 is a plot of cell density versus the number of days in an example embodiment for cell culture.

### DETAILED DESCRIPTION OF THE PREFERRED EMBODIMENTS

Before describing the present disclosure in detail, it is to be understood that this disclosure is not limited to particularly exemplified apparatus, systems, methods, or process parameters that may, of course, vary. It is also to be understood that the terminology used herein is only for the purpose of describing particular embodiments of the present disclosure and is not intended to limit the scope of the disclosure in any manner.

All publications, patents, and patent applications cited herein, whether supra or infra, are hereby incorporated by reference in their entirety to the same extent as if each individual publication, patent, or patent application was specifically and individually indicated to be incorporated by reference.

The term “comprising” which is synonymous with “including,” “containing,” or “characterized by,” is inclusive or open-ended and does not exclude additional, unrecited elements or method steps.

It will be noted that, as used in this specification and the appended claims, the singular forms “a,” “an” and “the” include plural referents unless the content clearly dictates otherwise. Thus, for example, a reference to a “partition” includes one, two, or more partitions.

As used in the specification and appended claims, directional terms, such as “top,” “bottom,” “left,” “right,” “up,” “down,” “upper,” “lower,” “proximal,” “distal” and the like are used herein solely to indicate relative directions and are not otherwise intended to limit the scope of the disclosure or claims.

Where possible, like numbering of elements has been used in various figures. Furthermore, multiple instances of an element and or sub-elements of a parent element may each include separate letters appended to the element number. For example, two instances of a particular element “10” or two alternative embodiments of a particular element may be labeled as “10a” and “10b”. In that case, the element label may be used without an appended letter (e.g., “10”) to generally refer to all instances of the element or any one of the elements. Element labels, including an appended letter (e.g., “10a”) can be used to refer to a specific instance of the element or to distinguish or draw attention to multiple uses of the element. Furthermore, an element label with an appended letter can be used to designate an alternative design, structure, function, implementation, and/or embodiment of an element or feature without an appended letter. Likewise, an element label with an appended letter can be used to indicate a sub-element of a parent element. For instance, an element “12” can comprise sub-elements or surfaces “12a” and “12b.”

Various aspects of the present devices and systems may be illustrated by describing components that are coupled, attached, and/or joined together. As used herein, the terms “coupled”, “attached”, and/or “joined” are used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements present. Furthermore, as used herein, the terms “connection,” “connected,” and the like do not necessarily imply direct contact between the two or more elements.

Various aspects of the present devices, systems, and methods may be illustrated with reference to one or more example embodiments. As used herein, the term “embodiment” means “serving as an example, instance, or illustration,” and should not necessarily be construed as preferred or advantageous over other embodiments disclosed herein.

Unless defined otherwise, all technical and scientific terms used herein have the same meaning as commonly understood by one of ordinary skill in the art to which the present disclosure pertains. Although one or more methods and materials similar or equivalent to those described herein can be used in the practice of the present disclosure, the preferred systems, materials and methods are described herein.

For example, the fluid mixing systems herein disclosed are configured for biological reactions, including but not limited to growing cells or other biological components. In example embodiments, fluid mixing systems can also comprise or be substituted with one or more bioreactors, fermenters, mixers, storage vessels, fluid management systems, cell culture equipment, centrifuges, centrifugal separators, chromatography units, mixers, homogenizers, magnetic processing units, blood separating devices, biocomponent filtering devices, biocomponent agitators or any other device designed for growing, mixing or processing cells and/or other biological components. It is also appreciated that fluid mixing systems can comprise any conventional bioreactor, fermenter, or cell culture device, such as a stirred-tank reactor, rocker-type reactor, paddle mixer reactor, or the like. In general, fluid mixing systems are configured for mixing fluids or bioprocess fluids 201 in the above-mentioned various bioprocessing pieces of equipment.

By way of example and not by limitation, the fluid 201 can include one or more biocomponents, including fluids, solids, mixtures, solutions, and suspensions including, but not limited to, bacteria, fungi, algae, plant cells, animal cells, white blood cells, T-cells, cell media, protozoans, nematodes, plasmids, viral vectors, blood, plasma, organelles, proteins, nucleic acids, lipids, plasmids, carbohydrates, and/or other biological components, and the like. Some common biological components grown in fluid 201 include E. coli, yeast, bacillus, and CHO cells. Fluid 201 can also comprise cell-therapy cultures, cells, and microorganisms that are aerobic, anaerobic, adherent, or non-adherent. Different media compositions known in the art can be used to accommodate the specific cells or microorganisms grown and the desired end product. In some uses, fluid mixing systems primarily grow and recover cells for subsequent use (e.g., preparing vaccine materials from the cells themselves). But in many uses, the ultimate purpose of growing cells in fluid mixing systems is to produce and later recover biological products (such as recombinant proteins, viral vectors, etc. . . . ) that are exported from the cells into the growth medium. It is common to use fluid mixing systems to grow cells in a master batch to prepare a specific volume, density, concentration, CFU, and/or aliquot of cells for subsequent use as an inoculant for multiple subsequent batches of cells grown to recover biological products. Fluid 201 for cell culture incorporates microcarriers to achieve high cell density in relatively low volumes due to their high surface-to-volume ratio. Microcarriers can contain a polymeric backbone fabricated from dextran, polystyrene, glass, cellulose, gelatin, collagen, alginate, and chitosan. biocompatible and biodegradable polymers such as poly (lactic-co-glycolic acid) (PLGA), polylactide (PLA), and poly(ε-caprolactone) (PCL).

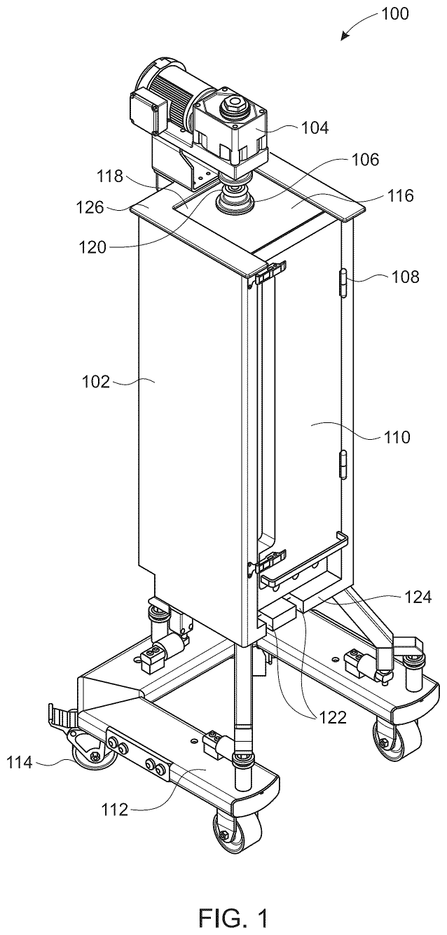

FIG. 1 illustrates a fluid mixing system 100 according to various embodiments. The mixing system 100 generally comprises a rigid housing 102, a motor 104 mounted to the rigid housing 102, a first bearing assembly 106 in rotational communication with the motor 104 through a drive shaft 120 and providing rotational movement to the interior of a flexible container 118, hinges 108 to secure a door 110 to the rigid housing 102 and provide enclosure for the flexible container 118, a rigid housing support 112 for the rigid housing 102 to mount thereto, and a support wheels 114 affixed to the rigid housing support 112 and provide mobility to the mixing system. The rigid housing 102 can have rigid housing openings 122 cut into rigid housing floor 124 for retaining various ports 228 and a second bearing assembly 222 from the flexible container 118. In some embodiments, the rigid housing can be fixed and does not require support wheels 114.

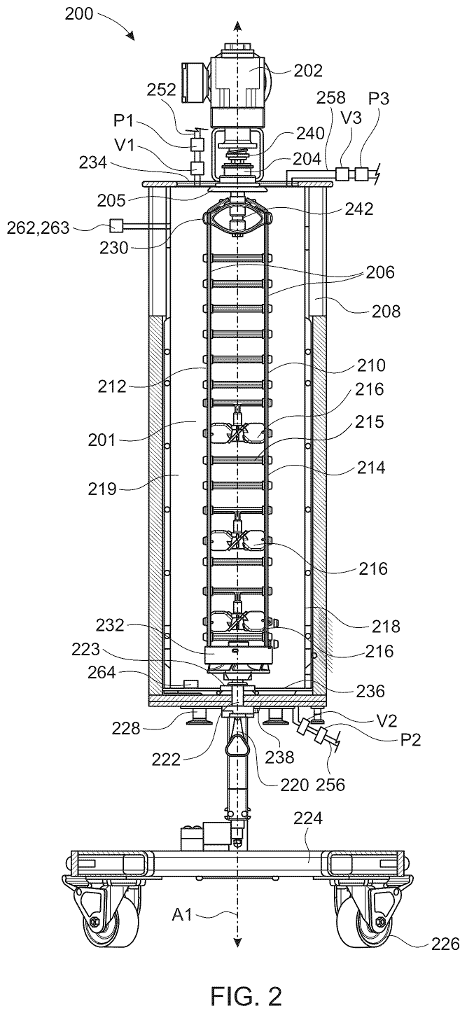

FIG. 2 illustrates a cross-sectional view of a fluid mixing system 200 according to various embodiments. Fluid mixing system 200 is an example of fluid mixing system 100 described above. The mixing system 200 comprises a rotary motor 202 mounted to a rigid housing 208, which has a drive shaft 240 that is in sterile, rotational communication to the interior of a flexible container 218 through a first bearing assembly 204. Further, the flexible container 218 bounds a compartment or chamber 219 around a centerline A1. The mixing system 200 also comprises a helical assembly 214 comprised of a top yoke 230 and a bottom mixing apparatus or impeller 232 that suspends a driveline 206 between a first end 234 and second end 236 of the flexible container 218. The bottom mixing apparatus 232 can be mounted to a second bearing assembly 222 to provide rotational movement to the helical assembly 214 on an opposing end of the flexible container 218. The bottom mixing apparatus 232, also known as the turbine impeller or turbine-shaped impeller, is described in detail later in this disclosure. Other helical assembly designs and their attachment methods are described in U.S. Pat No. 11,352,598 issued on Jun. 7, 2022, which is incorporated herein by specific reference in its entirety. One or more middle impeller 216 can be mounted to the helical assembly 214 to provide mixing to fluid 201 within the flexible container 218. Various other designs of middle impellers and their attachment methods are described in US2021/237009A1, published on Aug. 5, 2021, which is incorporated herein by specific reference in its entirety.

To facilitate the installation of the flexible container 218 into the rigid housing 208, a pull handle 220 can be mounted to the second end 236 of the flexible container 218 and, in some embodiments, onto the second bearing assembly 222. The rigid housing 208 can be mounted to a rigid housing support 224 and support wheels 226 can be attached to the rigid housing support 224 to provide mobility to the mixing system 200. In various embodiments, the flexible container 218 further comprises at least one port 228 that can protrude through the rigid housing floor 238.

In various embodiments, a user can open the door 110 to the rigid housing 208 for easy installation of the flexible container 218. As seen in FIG. 1, when the door 110 move to an open position the top surface 126 of the rigid housing 102, 208 can be completely open on the front face. The top surface 126 can make a “U” perimeter shape that comprises a back portion and two side portions that extend toward the door. While the door 110 is in the open configuration the flexible container 118, 218 can be moved into the chamber of the rigid housing 102, 208. The first bearing assembly 106, 204 located on the first end 116, 234 of the flexible containers 118, 218 can then be inserted onto the drive shaft 120, 240. Additional disclosure relating to mounting the flexible container 118, 218 to the drive shaft 120 can be found in US 2017-0183617, filed on Dec. 28, 2016 which is incorporated herein by specific reference in its entirety. Hangers (not shown) attached to the rigid housing 102, 208 can be hooked onto loops (not shown) on the flexible container 118, 218 to further secure the flexible container 118, 218 to the top surface 126 of the rigid housing 102, 208. Once the first end 116 of the flexible container 118, 218 is secured to the top surface 126 of the rigid housing 102, 208 the second end 236 can slide into the rigid housing floor 124, 238. In various embodiments, the flexible container 118, 218 will comprise one or more ports 228 and a second bearing assembly 222 that protrude from the exterior of the second end 236 of the flexible container118, 218. Rigid housing opening 122 in the rigid housing floor 124, 238 can be configured to accept the ports 228 and second bearing assembly 222, thereby, securing the second end 236 of the flexible container 118, 218 to the rigid housing floor 124, 238 of the rigid housing 102, 208. In some embodiments, a closure (not shown) can cover the rigid housing opening 122 to further secure the ports 228 and second bearing assembly 222 to the rigid housing floor 124, 238 of the rigid housing 102, 208. In various embodiments, a user can grip the pull handle 220 located at the second end 236 of the flexible container 118, 218 to pull the flexible container 118, 218 into place within the rigid housing 102, 208.

In various embodiments, once installation has been accomplished, the fluid 201 can be fed into the sterile compartment 219 of the flexible container 218, which can require mixing. Motor 104, 202 can be activated using a system controller 930 (not shown), which can then rotate the drive shafts 120, 240, which were inserted previously into the first bearing assembly 106. In some embodiments, there can be a single drive shaft 120, 240 that protrudes from the motor 104, 202 and into the sterile flexible container 118, 218, and in other embodiments, the first bearing assembly 106 will be closed off and have a second drive shaft portion 242 that extends from the first bearing assembly 106. In various embodiments, the drive shaft 120 or second drive shaft portion 242 will mount to a yoke 230 that works to space apart a first line 210 and a second line 212 of the driveline 206. In other embodiments, first line 210 and second line 212 can be connected to form a continuous drive line 206. On the second end 236 of the flexible container 118, 218 there can be a second bearing assembly 222 comprising a bottom mixing apparatus 232 that operates to suspend the other ends of the first line 210 and the second line 212 as well as provide mixing as it rotates. The second bearing assembly 222 can be designed to provide rotational movement so that rotation allows the helical assembly 214 to freely rotate as the motor 104, 202 drives the helical assembly 214 from the opposing end. One or more middle impellers 216 can mix in addition to the bottom mixing apparatus 232. Also, the first and second bearing assemblies 204, 222 can be driven magnetically to rotate the mixing helical assembly 214 and the bottom mixing apparatus 232. In various embodiments, the first line 210 is spaced apart from the second line 212 and is joined by a plurality of rungs 215. The yoke 230, bottom mixing apparatus 232, and plurality of rungs 215 can provide lateral spacing for the drive lines 210, 212.

In various embodiments, an added advantage of the bottom mixing apparatus 232 is it provides very low-volume mixing. For example, a bioprocess can require a small volume at the beginning, and the fluid volume can increase as the bioprocess progresses. Currently, available bioprocessing equipment has limitations with scale-up, which the present embodiment reduces. The middle impellers 216 can be affixed at various locations on the helical assembly 214 when considering optimal scale-up for a given bioreactor. In some embodiments, the bottom mixing apparatus 232 can maintain a homogenous mix in the fluid at a very low volume during a cell culture process. In particular, bottom mixing apparatus 232 is advantageous in providing low shear agitation for fluid 201 containing stem cells, CAR-T cells, viral vaccines, such as HEK293, sensitive carrier cultures, MSC, iPSC, and some biologics, including bioconjugates.

In various embodiments, the flexible container 218 can include one or more inlet 252 and outlet 256. The inlet 252 can be used during the installation process to add a gas to the flexible container 218 to inflate the flexible container 218 to its working volume. Additionally, inlet 252 can be used to introduce dry media, buffers, liquid nutrients, or anything else requiring mixing. Outlet 256 can be used to harvest the contents of the flexible container 218 after a mixing process is complete or a bioreaction has achieved a desired state. Additionally, an exhaust outlet 258 can be used to let out exhaust gases generated within the flexible container 218. There are various ways known in the art of attaching inlet 252, outlet 256, and exhaust outlet 258. A common technique is to weld the component to the flexible container 218. For example, the component can include a polymer that can be welded to the polymer comprising the flexible container 218. US 2017-0183617 includes common weldable materials used to produce flexible containers 218. For example, flexible container 218 can be formed from one or more sheets of polymeric film.

In various embodiments, sensor port 262 coupled to sensor 263 can be used to monitor the environmental conditions within the flexible container 218. There are a variety of sensor port 262 available on the market, including those described in US 2008-0032389 filed on Mar. 26, 2007, which is incorporated herein by specific reference in its entirety. Various techniques are described in the above-cited reference, disclosing ways to bond the sensor port 262 to the flexible container 218 using welding and adhesion methods. In FIG. 2, sensor port 262 is shown attached to a top portion of a right-side wall of the flexible container 218, but other attachment positions, including the top wall, and other side walls, fall under the scope of this disclosure. In various embodiments, when bioreactions are carried out in flexible containers 218, they often require the introduction of a gas, typically done using a sparger 264 in the field of bioproduction. A variety of the sparger 264 designs and their attachment methods are described in US 2013-0082410 filed on Sep. 28, 2012, which is incorporated herein by specific reference in its entirety.

In various embodiments, the mixing systems 100, 200, described herein can be used for cultivating cells using microcarriers and then harvesting the cells in their entirety or harvesting a cell byproduct such as a protein or enzyme. Types of microcarriers include but are not limited to nonporous positively charged carriers, surface-coated carriers (e.g., collagen-coated), noncharged or negatively charged carriers, and microporous carriers. Microcarriers can range in size from less than 100 micrometers to greater than 200 micrometers in diameter, with 100-200 micrometers being more common. Microcarrier densities can range from less than 1.03 g/mL to more than 1.05 g/mL, with 1.03-1.05 g/mL being more common.

In various embodiments, the first bearing assembly 204 and the second bearing assembly 222 can include a first annular sealing flange 205 and a second annular sealing flange 223 that can be sealed to openings on the flexible container 218 by welding or adhesive around the perimeter. As disclosed in US 2017-0183617, this allows for rotational movement of a hub while an outer casing remains fixed to the flexible container 218, allowing the helical assembly 214 to freely rotate within the flexible container 218 while remaining sterile to the exterior. In various embodiments, the optimal location of the helical assembly 214 relative to the flexible container 218 will be along the centerline A1. In various other embodiments, the optimal location of the helical assembly 214 relative to the flexible container 402 will be offset from the centerline A1, more towards a side or corner of the flexible container 218.

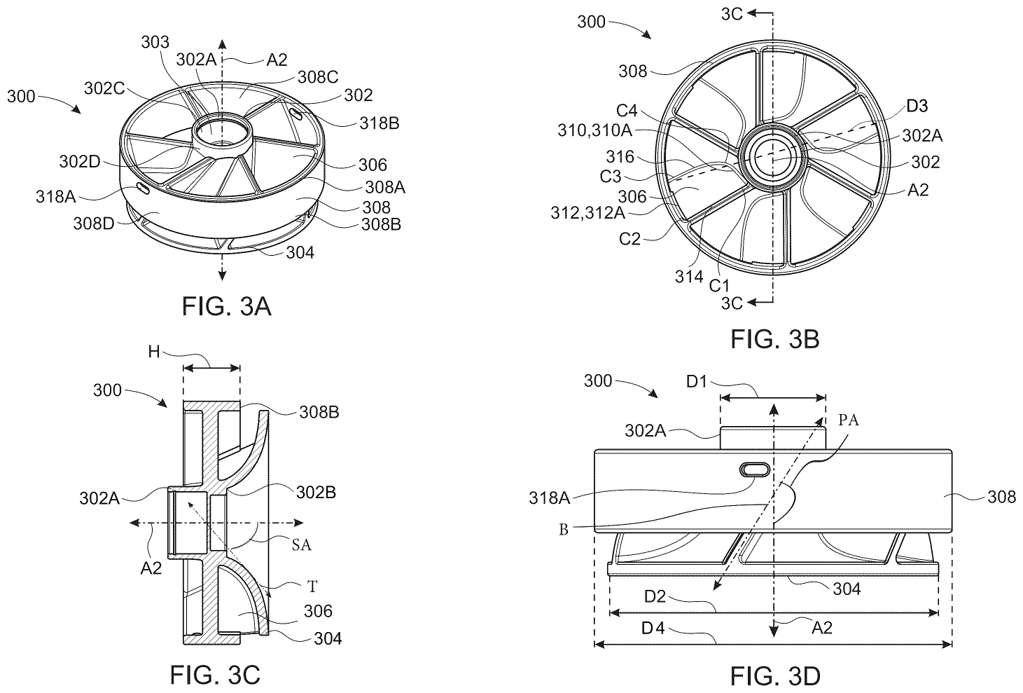

Referring now to FIGS. 3A, 3B, 3C, and 3D, an embodiment of the mixing apparatus 300 is shown in a perspective view, in a top view, in a cross-section view, and in a side view, respectively. Mixing apparatus 300 is an example of a bottom mixing apparatus 232 described above. Mixing apparatus 300 includes a hub 302 having a central opening 303 extending between a top portion 302A and a bottom portion 302B along a centerline A2. Further, the hub 302 includes an interior surface 302C and an exterior surface 302D. The hub 302 comprising the top and bottom portions 302A, 302B can be formed as one integral unit or be coupled to each other in a modular configuration by welding and adhesion techniques. In example embodiments, top portion 302A has a substantially cylindrical cross-section with a uniform diameter of D1, whereas bottom portion 302B has a substantially frustoconical cross-section extending to a base flange 304 having a diameter of D2. A frustoconical shape of the base flange 304 extending from hub 302 forms a sloping floor to facilitate the channeling of fluid 201 from axial flow to radial flow. The base flange 304 extending from the hub 302 can have a uniform slope angle SA relative to centerline A2. The slope angle SA is represented as the angle SA between a tangent T of the base flange 304 and the centerline A2. In other examples, portions of the base flange can have variable slope angles SA relative to centerline A2 for channeling fluid 201.

In the example shown in FIGS. 3A, 3B, 3C, and 3D, diameter D1 of the top portion of hub 302 is less than diameter D2 of the base flange 304. The top portion 302A of hub 302 can include grooves, threading, tabs, protrusions, indentations, or any other coupling or engaging features on the inner surface 302C to receive mixing apparatus cap 400 or a drive shaft/pin, described later in this disclosure. The engaging features can include the interior surface 302C having polygonal shapes to complement a polygonal shape of the drive shaft received in the top portion of 302A of the hub 302.

One or more blades 306 extend radially from the exterior surface 302D of the top portion 302A of the hub 302 to a shroud wall 308 circumferentially surrounding at least a portion of the top portion 302A of the hub 302. In the example shown in FIGS. 3A, 3B, 3C, and 3D, six blades are shown radially extending from top portion 302A of the hub 302 to shroud wall 308; any number of blades but not limited to two, three, four, five, or more than six blades fall under the scope of this disclosure. In example embodiments, each of the one or more blades 306 has a flat, planar configuration and a quadrilateral shape, with at least one rounded corner or edge. In other examples, each of the one or more blades 306 can have non-planar configurations, polygonal shapes with rounded corners, sharp corners, straight edges, or rounded edges. Each of the one or more blades 306 has a first edge 310, a corresponding second edge 312 opposite to the first edge 310, a third edge 314, and a corresponding fourth edge 316 opposite to the third edge 314, forming a quadrilateral shape. At least a first portion 310A of the first edge 310 is coupled to exterior surface 302D of the top portion 302A of the hub 302, at least a first portion 312A of the second edge 312 is coupled to the shroud wall 308, and at least a portion of the fourth edge is coupled to the base flange 304. Third edge 314 is straight, whereas fourth edge 316 is curved. First and third edges 310, 314, second and third edges 312, 316, second and fourth edges 312, 316 meet at sharp corners, C1, C2, and C3, respectively, while first and fourth edges 310, 316 meet at a round corner C4. Other shapes for each of blades 306 with various combinations of straight or curved edges and corners fall under the scope of this disclosure. Each of the one or more blades 306 is aligned at an angle or pitch angle PA ranging between 30-70 degrees with centerline A2 of hub 302. The pitch angle PA is represented as the angle or supplementary angle PA between a blade axis B and the centerline A2. In other examples, a pitch angle less than 30 degrees or more than 70 degrees also falls under the scope of this disclosure. Each of the blades 306 can be identical in shape or have different shapes and combinations of edges, corners and angles. Each of the blades 306 can be coupled to the hub 302 by welding and adhesion techniques or the hub 302 and each of the blades 306 can be built as one integral unit. In other examples, each of the blade 306 can be removably coupled to the hub 302, providing options for customizing the number of blades based on the working volume of the fluid and the volume of the container used for the cell culture process.

Shroud wall 308 has a cylindrical cross-sectional shape with a top end 308A, a bottom end 308B, an interior surface 308C, and an exterior surface 308D. Shroud wall 308 is coaxial with the top portion 302A of the hub 302 along centerline A2 of the hub 302. The shroud wall 308 has a pair of apertures 318A, 318B extending between interior and exterior surfaces 308C, 308D and disposed at diametrically opposed positions on the shroud wall 308. The apertures 318A and 318B are used for engaging drive line 206, including first and second drive lines 210 and 212 of helical assembly 214 described above. In the example shown in FIGS. 3A, 3B, 3C, and 3D, the top portion 302A of hub 302 extends to the same extent and above top end 308A of shroud wall 308. In other examples, the top portion 302A of hub 302 can align with the top end 308A of shroud wall 308. The Shroud wall 308 has an inner diameter D3 which matches with the diameter of the base flange D2. The shroud wall has an outer diameter D4 greater than (i) diameter D1 of the top portion of the hub 302A, (ii) diameter D2 of the base flange 304, and (iii) inner diameter of the shroud D3. Further, the shroud wall 308 is vertically spaced apart from the base flange 304.

In an example embodiment, geometrical features for mixing apparatus 300, include the following parameters: Outer Diameter D4 of shroud wall 308: ranging between 5.0-6.0 inches, with 5.4 inches being more common; Overall Height H of mixing apparatus 300 ranging between 2.0-3.0 inches with 2.73 inches being more common; Number of Blades 306: ranging between 2-12 or more blades with six blades being more common; Pitch angle PA of Blades 306: ranging between 30-70 degrees relative to centerline A1, with 60 degrees being more common; Ratio of Intake/Output: 2.56 (This ratio represents the ratio of the surface area at the top of the mixing apparatus 232, 300 in comparison to the surface area of the bottom of the mixing apparatus 232, 300); Distance from floor of the flexible container 218 to bottom of mixing apparatus 232, 300: ranging between 0.4-0.8 inches with 0.56 inches being more common. In other examples mixing apparatus 232, 300 can have values for overall diameter D3, overall height H, number of blades 306, angle of blades, ratio of intake/output, and distance from the floor, different from the ranges described above.

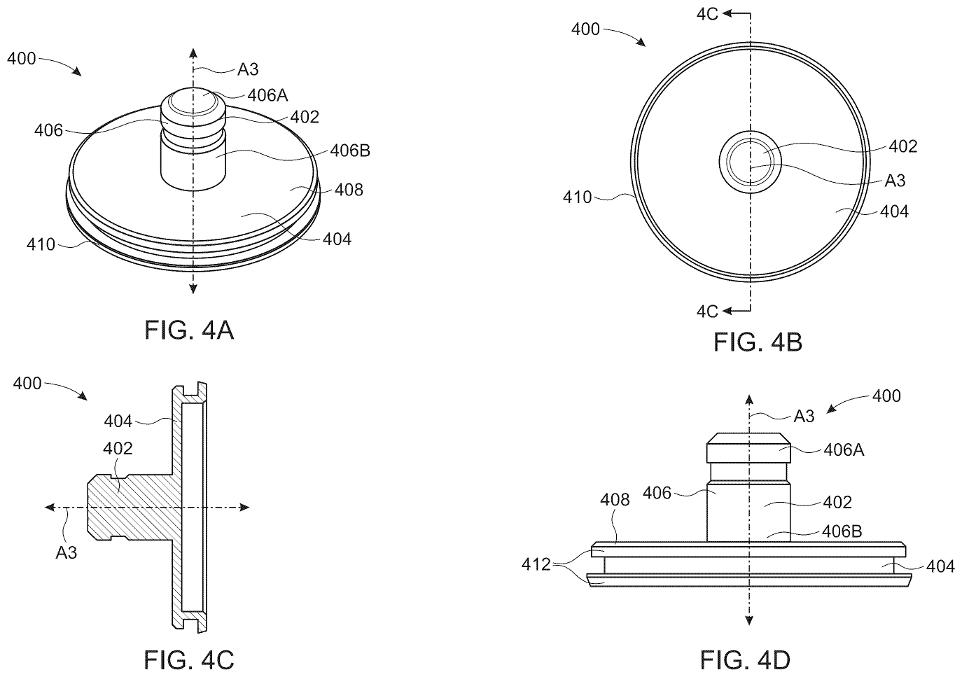

Referring now to FIGS. 4A, 4B, 4C, and 4D, an embodiment of a cap 400 for mixing apparatus 300, is shown in a perspective view, in a top view, in a cross-section view, and in a side view, respectively. The cap 400 can also be used with bottom mixing apparatus 232 described above in FIG. 2. Cap 400 includes a top portion 402, and a bottom portion 404. The top portion 402 of the cap 400 includes a cylindrical post 406 having a top end 406A and a bottom end 406B extending along a centerline A3. The bottom portion 404 includes a flange 408 circumferentially extending orthogonal to the centerline A3 of the cylindrical post 406. Further, a perimeter 410 of the flange 408 includes a pair of step-like protrusions 412. The step-like protrusions 412 are configured to be received in the top portion 302A of the hub 302 of the mixing apparatus 300 described above. The cap 400 seals the opening 303 of the top portion 302A of the hub 302, thus avoiding entry of fluid 201 into the mixing apparatus 300 during a cell culture process.

Mixing apparatus 232, 300, including hub 302, base flange 304, one or more blades 306 and shroud wall 308, and mixing apparatus cap 400, can be made of high-density polyethylene, Vectra Liquid Crystalline Polymer (LCP), Ultrason-Polyphenylsulfone (PPSF or PPSU), any high-performance polymer having rigid or semi-rigid characteristics or similar material suitable for handling fluids in bioprocessing equipment. Similarly, mixing apparatus 232, 300, and mixing apparatus cap 300 can be made via mill machining, 3D printing, or injection molding techniques.

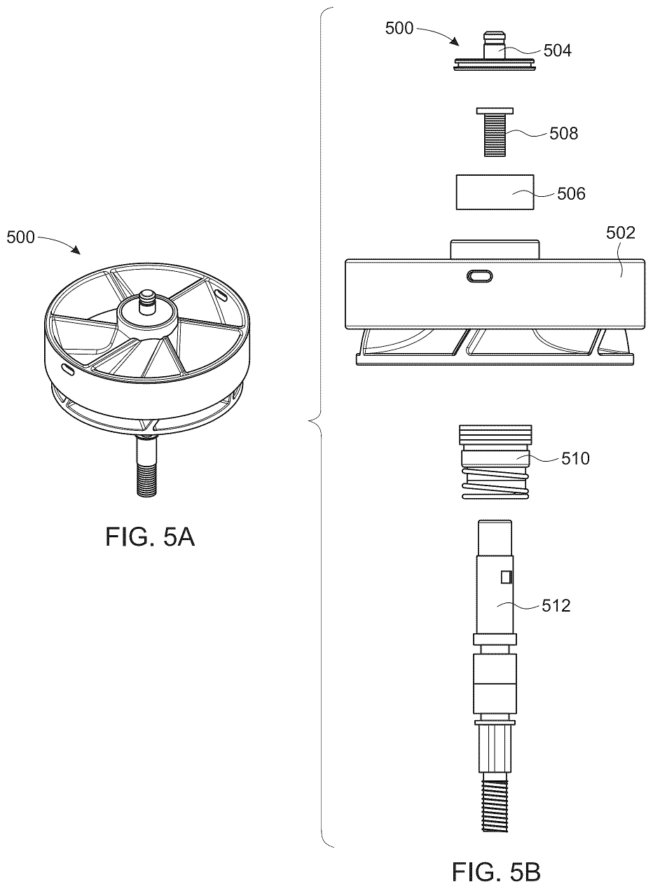

Referring to FIGS. 5A and 5B, an embodiment for mixing assembly 500, is shown in perspective and exploded views, respectively. Mixing assembly 500 is an example of an assembly that can be used in the mixing system 200 described above in FIG. 2. The mixing assembly 500 is a machined version made by a milling process. Mixing assembly 500 comprises a mixing apparatus 502 and mixing apparatus cap 504 machined as separate integral units and assembled in a press fit assembly process. Further, mixing apparatus 500 comprises contact bearing 506, a bottom bearing pin screw 508, a mechanical pump shaft seal with extended spring 510, and a bottom bearing pin 512. Bottom bearing pin 512 and mechanical pump shaft seal 510 can be received in mixing apparatus 502 and secured by bottom bearing pin screw 508 and contact bearing 506, facilitating rotation of mixing apparatus 502.

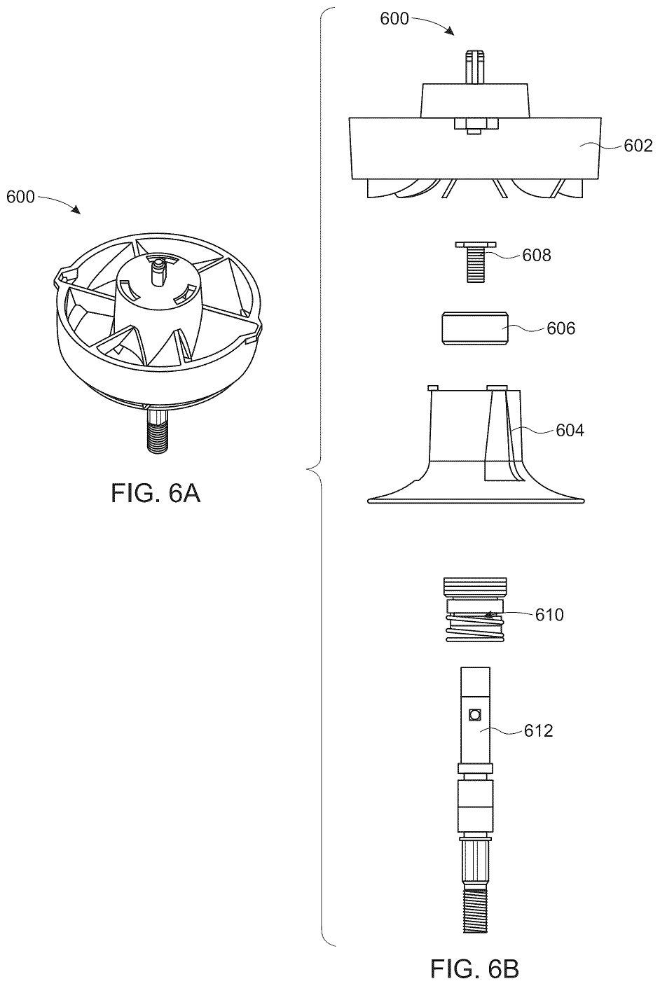

Referring to FIGS. 6A and 6B, embodiments of mixing assembly 600, are shown in perspective and exploded views, respectively. Mixing assembly 600 is an example of an assembly that can be used in the mixing system 200 described above in FIG. 2. Mixing assembly 600 is made by injection molding process. Mixing assembly 600 comprises a top portion of mixing apparatus 602 and a bottom portion of mixing apparatus 604 molded as separate integral units and assembled in a press fit assembly process. Further, mixing apparatus 600 comprises contact bearing 606, a bottom bearing pin screw 608, a mechanical pump shaft seal with extended spring 610, and a bottom bearing pin 612. The bottom portion of mixing apparatus 604 can be received in the top portion of mixing apparatus 602 and secured by bearing pin 612 and mechanical pump shaft seal 610 and bottom bearing pin screw 608, and further contact bearing 606, facilitating rotation of mixing assembly 600.

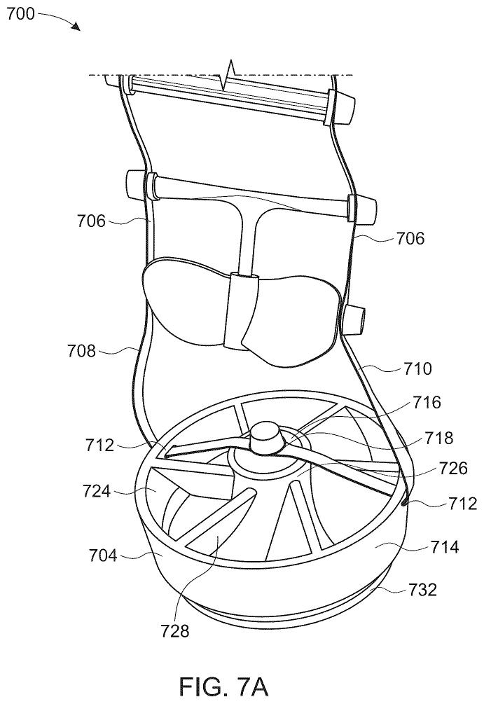

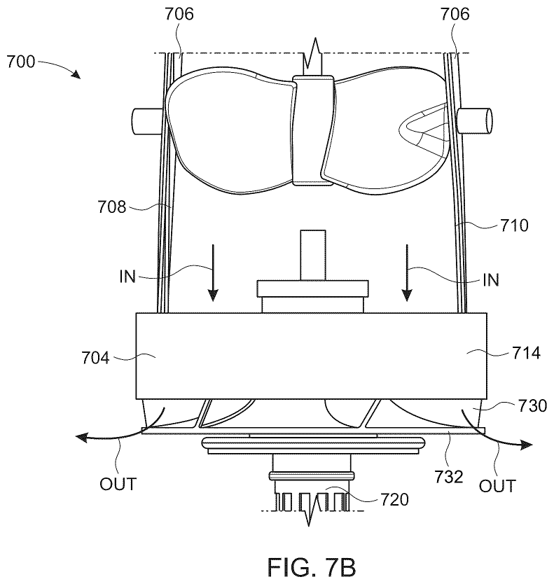

Referring to FIGS. 7A and 7B, embodiments for mixing assembly 700, are shown in partial perspective and front views, respectively. Mixing assembly 700 is an example of an assembly that can be used in the mixing system 200 described above in FIG. 2. Mixing assembly 700 comprises mixing apparatus 704 connected to helical assembly 706. Mixing apparatus is an example of mixing apparatus 232, 300 described above and has similar parts. In other words, mixing apparatus 704 is engaged with a first drive line 708 and a second drive line 710 of the helical assembly 706 through a pair of apertures 712 on a shroud wall 714 of the mixing apparatus 704. A cap 716 of the mixing apparatus 704 can also have a pair of openings 718 for routing the drive line 706. The mixing apparatus 704 is coupled to the bottom bearing assembly (not shown in FIGS. 7A, but shown in FIG. 7B) through a bottom bearing pin 720. It may also be noted that mixing apparatus 704 can help maintain the helical assembly 706, including the drive lines 708 and 710, in an anti-tangle configuration. Upon a rotary motor's application of a rotary force, the helical assembly 706 and/or bearing pin 720 rotate, which rotates the mixing apparatus 704. As mixing apparatus 704 rotates, fluid enters in an axial direction, ‘IN,’ into an interior space 724 of the mixing apparatus 704. The interior space 724 can be defined as the space for fluid flow between the hub 726, blades 728 and shroud wall 714. Further, the fluid moves through the mixing apparatus 704 and exits out in a radial direction along the direction ‘OUT’ through a spacing 730 between the shroud wall 714 and base flange 732. In an example, the mixing apparatus 704 can be rotated at a rpm in the range of 30-40 rpm, with 35 rpm being more common for a working volume of 7.5 L of fluid 201 in container 218.

In other words, the mixing 704 apparatus can be referred to as the turbine impeller being configured to (i) receive the fluid 201 in an axial direction into an interior space 724 of the mixing apparatus 704 and (ii) distribute the fluid radially towards the interior surface of the container 218. The mixing assembly 704 is configured to transform an axial flow of fluid 201 into a radial flow, thus providing efficient agitation of microcarriers and cells and avoiding stagnation regions during the cell culture bioprocesses. The mixing assembly, also termed as turbine impeller assembly 704, brings about such a flow path (axial flow to radial flow), providing low shear agitation to the fluid 201 comprising shear-sensitive cell lines and microcarriers.

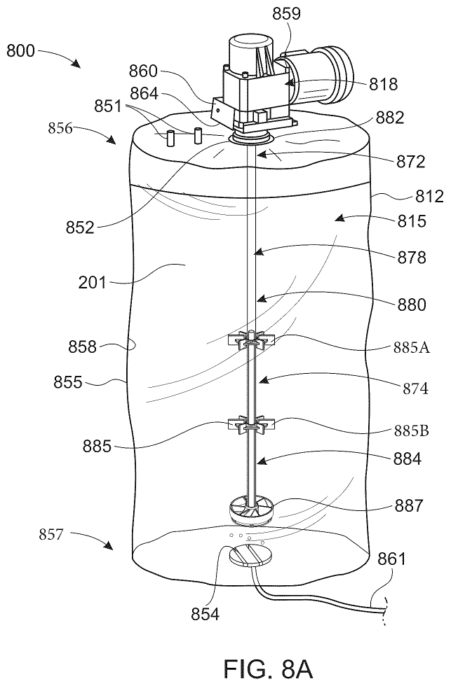

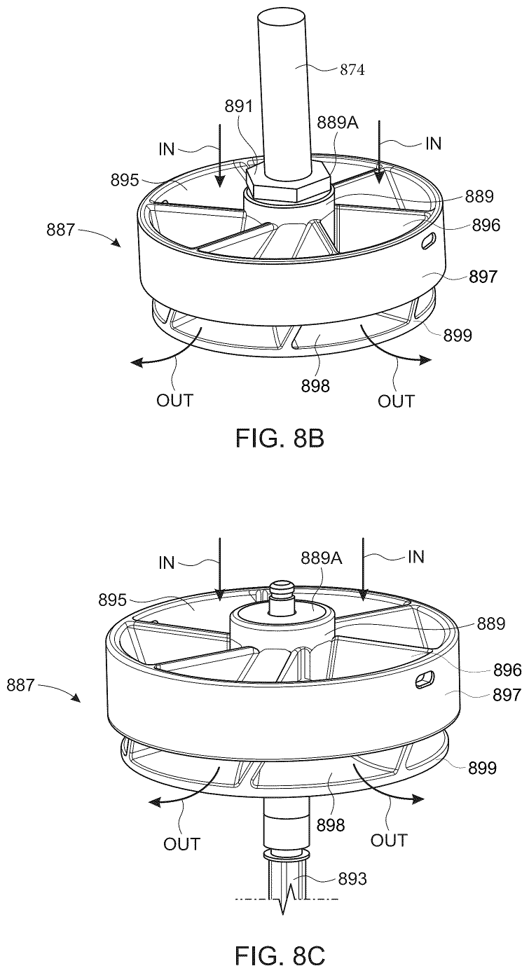

FIG. 8A shows a fluid mixing system 800 including a container 812 coupled with mixing assembly 818 comprising a mixing apparatus or impeller 887. Mixing apparatus 887 forms an example of the mixing apparatus 232, 300 described above and has similar parts. Container 812 has a side 855 that extends from a first end 856 to an opposing second end 857. Container 812 also has an interior surface 858 that bounds the inner compartment or chamber 815 in which a portion of mixing assembly 818 is disposed. In the embodiment depicted, container 812 comprises a flexible bag. Formed on container 812 are a plurality of ports 851 that communicate with inner chamber 815. Although only two ports 851 are shown, it is appreciated that container 812 can be formed with any desired number of ports 851 and that ports 851 can be formed at any desired location on container 812 such as first end 856, second end 857, and/or alongside 855. Ports 851 can be the same configuration or different configurations and can be used for a variety of different purposes. For example, ports 851 can be coupled with fluid lines for delivering media, cell cultures, and/or other components into and/or out of container 812.

Ports 851 can also be used for coupling probes to container 812. For example, when container 812 is used as a bioreactor for growing cells or microorganisms, ports 851 can be used for coupling probes such as temperatures probes, pH probes, dissolved oxygen probes, foam sensors and the like. Examples of ports 851 and how various probes and lines can be coupled thereto is disclosed in United States Patent Publication No. 2006-0270036, published Nov. 30, 2006 and United States Patent Publication No. 2006-0240546, published Oct. 26, 2006, which are incorporated herein by specific reference. Ports 851 can include various tubing and can be used for coupling container 812 to secondary containers and to other desired fittings.

In various embodiments, means are provided for delivering a gas into the second end 857 of container 812. By way of example and not by limitation, as also depicted in FIG. 2, a sparger 854 can be either positioned on or mounted to the second end 857 of container 812 for delivering a gas to the fluid within container 812. As is understood by those skilled in the art, various gases are typically required in the growth of cells or microorganisms within container 812. The gas typically comprises air that is selectively combined with oxygen, carbon dioxide and/or nitrogen. However, other gases can also be used. The addition of these gases can be used to regulate the dissolved oxygen and CO₂ content and to regulate the pH of a culture solution. Depending on the application, sparging with gas can also have other applications. A gas line 861 is coupled with sparger 854 for delivering the desired gas to sparger 854. Gas line 861 need not pass through the second end 857 of container 812 but can extend down from the first end 856 or from other locations.

In the depicted embodiment, container 812 has an opening 852 that is sealed to a rotational assembly 882 of mixing assembly 818. As a result, the inner chamber 815 is sealed closed so that it can be sterilized and used in processing sterile fluids. During use, container 812 can be disposed within a chamber of a support housing. Container 812 is supported by support housing during use and can subsequently be disposed of following use. Examples of support housing for container 812 can be found at U.S. Pat No. 103,35,751, issued on Jul. 2, 2019, which is incorporated herein by specific reference. In one embodiment, container 812 is comprised of a flexible, water impermeable material such as a low-density polyethylene or other polymeric sheets or film having a thickness in a range between about 0.1 mm to about 5 mm with about 0.2 mm to about 2 mm being more common. The material is approved for direct contact with living cells and is capable of maintaining a sterile solution. In such an embodiment, the material can also be sterilizable such as by radiation. Examples of materials that can be used in different situations are disclosed in U.S. Pat. No. 6,083,587 which issued on Jul. 4, 2000 and United States Patent Publication No. US 2003-0077466 A1, published Apr. 24, 2003, which are hereby incorporated by specific reference.

It is appreciated that container 812 can be manufactured to have virtually any desired size, shape, and configuration. For example, container 812 can be formed having a compartment 815 sized to 7.5 liters, 10 liters, 30 liters, 100 liters, 250 liters, 500 liters, 750 liters, 1,000 liters, 1,500 liters, 3,000 liters, 5,000 liters, 10,000 liters or other desired volumes. The size of the compartment 815 can also be in the range between any two of the above volumes. Although container 812 can be any shape, in one embodiment container 812 is specifically configured to be complementary or substantially complementary to chamber of the support housing. It is desirable that when container 812 is received within chamber, container 812 is at least generally uniformly supported by support housing. Having at least general uniform support of container 812 by support housing helps to preclude failure of container 812 by hydraulic forces applied to container 812 when filled with fluid. Although in the above-discussed embodiment, container, 812 has a flexible, bag-like configuration, in alternative embodiments, it is appreciated that container 812 can comprise any form of a collapsible container, rigid or semi-rigid container. Container 812 can also be transparent or opaque and can have ultraviolet light inhibitors incorporated therein.

Mixing system 800 is used for mixing and/or suspending a culture or other solution or suspension within container 812. As depicted in FIG. 8, mixing assembly 818 generally comprises a drive motor assembly 859 that is mounted on the support housing, and an impeller assembly 878 coupled to and projecting into container 812. The impeller assembly 878 extends between drive motor assembly 859 and mixing apparatus 887 and includes an elongated member 872 coupled to a drive shaft 874. In some embodiments, the elongated member 872 can have a hollow tubular or solid-closed structure and extend or couple between the first end 856 of the container 812 and the mixing apparatus 887. In some embodiments, the drive shaft 874 can extend or couple between the first end 856 of the container 812 and the mixing apparatus 887 by extending through the hollow elongated member 872. In some embodiments, the drive shaft 874 itself can extend or couple between the first end 856 of the container 812 and the mixing apparatus 887. In some embodiments, the elongated member 872 or drive shaft 874 can include more than one part coupled together and caused to rotate by the drive motor assembly 859. Examples of elongated member 872 and drive shaft 874 and their connections are disclosed in U.S. Pat. No. 97,00,857, issued on Jul. 11, 2017, is hereby incorporated by specific reference.

One or more middle impellers 885A, 885B can be coupled to the drive shaft 874. Alternatively, the middle impellers 885A, 885B can be coupled to the elongated member 872 or a combination of the elongated member 872 and drive shaft 874. In an example, middle impellers 885A, 885B can be spaced apart from each other and from the mixing apparatus 887 along the elongated member 872 and/or the drive shaft 874 or the combination of elongated member 872 and drive shaft 874 thereof. For example, impeller assembly 878 can be a part of and/or coupled to the drive shaft 874 such that when the drive shaft 874 rotates, the impeller assembly 878, including mounted middle impellers 885, and bottom mixing apparatus 887, rotates. In another example, middle impellers 885A and 885B can be replaced with mixing apparatus 887 to stir fluid in container 812 efficiently. Hence, the mixing apparatus 887 can be connected directly to the drive motor 859 through a single drive shaft 874 or a plurality of interconnected connectors including elongated member 872. Mixing apparatus 887 can include a central hub (similar to hub 302 of mixing apparatus 300) having an opening. The central hub can have engaging features on the interior side of the hub to engage with the drive shaft and connectors. As such, as disclosed herein, when reference is made to a feature being coupled to the elongated member 872 or drive shaft 874, such feature can be coupled directly or indirectly to the elongated member 872 or drive shaft 874. Optionally, the mixing apparatus 887 can be connected at the bottom portion to a bearing assembly through a bottom-mounted drive shaft configured to provide rotational movement to the mixing apparatus 887. Also, the drive shaft can be driven magnetically to rotate the mixing apparatus 887.

FIG. 8B illustrates the mixing apparatus 887 having a hub 889 with a top end 889A and a bottom end (not seen in FIG. 8B). Further, the top end 889A of the mixing apparatus is coupled to a drive shaft 874, wherein the hub 889 has a central opening and at least an interior side of a top portion of the hub 889 has coupling or engaging features to receive portions of the shaft 874. Further, a fastening component like a nut 891 can be fastened to secure the coupling between the drive shaft 874 and the mixing apparatus 887. FIG. 8C illustrates the mixing apparatus 887 coupled to a drive shaft 874 or drive pin 893 at the bottom end of the hub 889, wherein the hub 889 has a central opening and at least an interior side of a bottom portion of the hub 889 has coupling or engaging features to receive portions of the drive shaft 874 or drive pin 893. In an example embodiment, an interior side of the hub 889 of the mixing apparatus 887 can include coupling or engaging features comprising polygonal shapes to complement the outer shape of the drive shaft/drive pin 872, 893. The coupling or engaging features can also include grooves, indentations, tabs, protrusions, or threading to complement features on the drive shaft 874 or drive pin 893. The drive shaft 874 or drive pin 893 can be driven magnetically or by a rotary motor described above, to rotate the mixing apparatus 887.

In the above embodiments, upon application of a rotary force by a rotary motor, the drive shaft 874/drive pin 893 rotates and, in turn, rotates the mixing apparatus 887. As mixing apparatus 887 rotates, fluid enters in an axial direction, ‘IN,’ into an interior space 895 of the mixing apparatus 887. The interior space 895 can be defined as the space for fluid flow between the hub 889, blades 896 and shroud wall 897. Further, the fluid moves through the mixing apparatus 887 and exits out in a radial direction along the direction ‘OUT’ through a spacing 898 between the shroud wall 897 and base flange 899. In other words, the mixing 887 apparatus can be referred to as the turbine impeller being configured to (i) receive the fluid 201 in an axial direction into an interior space 895 of the mixing apparatus 887 and (ii) distribute the fluid radially towards the interior surface 858 of the compartment 815. The mixing apparatus 887 is configured to transform an axial flow of fluid 201 into a radial flow, thus providing efficient agitation of microcarrier cells and avoiding stagnation regions during the cell culture bioprocesses. The turbine-based mixing apparatus 887 brings about a transformation of the axial flow path to the radial flow path for fluid 201 in container 812.

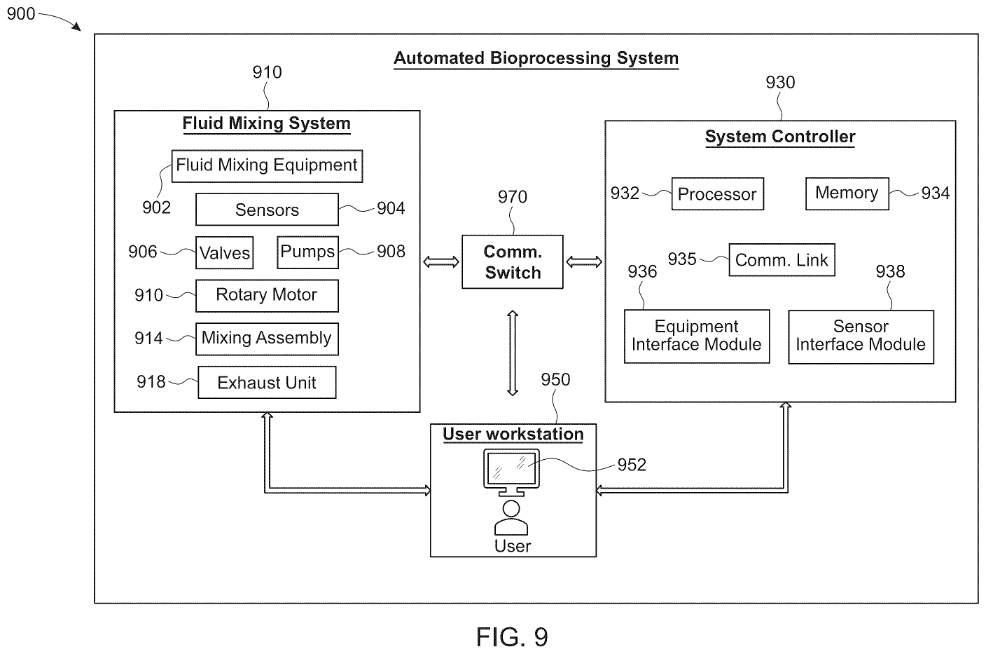

FIG. 9 is a block diagram of an automated bioprocessing system 900, consistent with implementations of the current subject matter. The bioprocessing system 900 is designed to mix fluid efficiently, particularly microcarrier suspension, in a specific piece of fluid mixing equipment to prevent stagnation zones. Thereby providing a homogenous suspension of microcarriers and cells while minimizing any damage to shear-sensitive cell lines. Automated bioprocessing system 900 can include a fluid mixing system 910 (also referred to as a fluid processing system) comprising mixing apparatus (232, 300, 704, or 887) and associated sensors 904 in electronic communication with a system controller 930, and a user workstation 950 operated by a user. A communication switch 970, for example, an ethernet IP switch, functions as a router to facilitate and balance communications and data transmission between fluid mixing system 910 and/or sensor 904 and sensor transmitter (not shown) associated with the system, system controller 930, and user workstation 950. Other communication links, routers, or switches can also facilitate and balance communications and data transmission between fluid mixing system 910, associated equipment, sensors 904, system controller 930, and user workstation 950.

Fluid mixing system 910 can include a piece of fluid mixing equipment 902, a plurality of sensors 904, a plurality of valves and/or associated manifolds 906, a plurality of pumps 908, a rotary motor 910, mixing assembly 914 comprising mixing apparatus 232, 300, 704, or 887, exhaust unit 918 and/or other peripherals, instruments, and bioprocessing equipment. For the purposes of this example, the fluid mixing equipment 902 is a bioreactor 902, but can be a fermentor, mixer, bioprocess container, storage tank, filter, pump, conduit or other bioprocessing equipment used to process biological or flow fluids. In an example embodiment, the fluid mixing equipment 902 in fluid mixing system 910 can be a Thermo Scientific™ DynaDrive™ Single-Use Bioreactors (S.U.B.s), Thermo Scientific™ Single-Use Fermentor (S.U.F.), any similar bioprocessing system, and fluid mixing system 100, 200, 800 described above.

Operations of the fluid mixing system 910, including the running of fluid mixing equipment 902, can be controlled by a system controller 930. Operation of one or more valves 906 and pumps (rotary pump) 908 can be controlled by analog or digital input modules, transmitters, communication hubs, communication channels, and/or other signal and data communication and/or processing devices for processing and exchanging data with the controller (e.g., Ethernet/IP codesys, DI/DO modules).

System controller 930 includes at least one processor 932 and at least one associated primary memory 934 for storing instructions, which, when executed by at least one processor 932, are configured to perform one or more operations, including process control operations for automating control of bioprocessing equipment. Further, a communication link 935 facilitates electronic communication between fluid mixing equipment 902, sensors 904, valves 906, pumps 908, a rotary motor 910, mixing assembly 914, exhaust unit 918, system controller 930, and user workstation 950, via communication switch 970. Communication link 935 can include any wired and/or wireless network, including, for example, a wide area network (WAN), a local area network (LAN), a virtual local area network (VLAN), a public land mobile network (PLMN), the Internet, and/or the like. All data interactions, including sending, receiving, writing, overwriting, and copying instructions, signals, and data between the above components, fluid mixing system 910, system controller 930, and user workstation 950, can be stored in memory 934.

In some implementations, memory 934 can be a centralized repository designed to store, process, and secure large amounts of structured, semi-structured, and unstructured data. In general, memory 934 can store and/or process the data received from fluid mixing system 910 and serve as a source of data for user workstation 950 and vice-versa. In various embodiments, portions of data stored in memory 934 can be configured to be transferred to plant or large-scale applications, while other portions of data can be used for bench-scale applications in a laboratory environment. For example, data stored in memory 934 can be used for data analytics, predictive protocols, and process optimization.

Further, system controller 930, includes an equipment interface module 936 and a sensor interface module 938, configured to generally interface with, receive and transmit signals and data to and from one or more operational components, peripherals, or equipment (valves 906, pumps 908) and sensors 904 (or associated transmitters) of the fluid mixing system 910. In various embodiments, the system controller 930 can be a single unit or a distributed control system with a client-side control component for client inputs and outputs and a plant-side control component closer in proximity to the bioprocessing plant.

A user can control operations of fluid mixing system 910 via user interface 952 displayed on user workstation 950. In particular, user interface 952, includes user inputs and readable instrument and process parameter outputs for controlling and monitoring fluid mixing system 910. For example, user workstation 950 can be configured to remotely control and monitor one or more operations of fluid mixing system 910 by receiving inputs/outputs from sensors 904, valves 906, pumps 908, a rotary motor 910, mixing assembly 914, exhaust unit 918 other equipment, or associated transmitters.

Referring back to FIG. 2, and as discussed previously, the automated bioprocessing system 900 includes controlling one or more operations of fluid mixing system 200 described in FIG. 2. Similarly, the automated bioprocessing system 900 can include controlling one or more operations of fluid mixing system 100 described in FIG. 1, or fluid mixing system 800 described in FIG. 8. In example embodiments, during cultivation of cells in fluid 201 in container 218, sensor 263 can be a cell density or turbidity sensor to provide data for the density or turbidity of microbial or cell suspensions in bioprocesses to sensor interface module 938, which can be saved as data set S1 in memory 934 of system controller 930. Optionally, during cultivation of cells in fluid 201 in container 218, sensor 263 can be a temperature sensor to provide data for temperature characteristics of fluid 201 with time to sensor interface module 938, which can be saved as data set S2 in memory 934 of system controller 930. Optionally, sensor 263 can be a pH sensor to provide data for pH variation for fluid 201 with time to sensor interface module 938, which can be saved as data set S3 in memory 934 of system controller 930. Optionally, sensor 263 can be a foam sensor to provide data for foam buildup above fluid 201 with time to sensor interface module 938, which can be saved as data set S4 in memory 934 of system controller 930. The system controller 930 can be configured to automatically process data sets S1, S2, S3, and S4 through processor 932 and to prepare instructions for the operation of equipment (valves 906, V1, V2, V3, and pumps 908, P1, P2, P3).

For example, if the cell density or turbidity of fluid 201, including microcarrier and cells in container 218 exceeds a threshold value, system controller 930 can control operations of the rotary motor 202 so that the helical driveline 214 and bottom mixing apparatus 232 is rotated at an rpm to mix the suspension of microcarrier and cells to provide a homogenous suspension with minimal damage to shear sensitive cell lines. In the initial stages of the cell culture process, the volume of fluid 201 in container 218 may be low, requiring a first rpm. Later, as the cell culture process progresses, the overall volume of the fluid 201 in the container increases. If fluid 201 is not mixed efficiently, stagnation or dead zones of microcarriers and cells can be formed in the fluid, leading to an overall decrease in harvest yields. In such cases, the system controller 930 can control the operations of the rotary pump 202 to rotate the helical assembly 214 at a second rpm to efficiently mix the suspension of the microcarrier and cells. In an example the first or second rpm can be in the range of 30-40 rpm with 35 rpm being more common for a working volume of 7.5 L of fluid in a container.

The system controller 930 is further configured to control pump P1 associated with inlet 252 to control fluid or medium inlet into container 218 through valve V1 based on the stage of bioprocessing. Similarly, system controller 180 is further configured to control pump P2 associated with outlet 256 to control fluid or medium flowing out of container 218 through valve V2 based on the stage of bioprocessing. Similarly, the system controller 180 is further configured to control pump P3 associated with gas outlet 258 to exhaust gases flowing out of container 218 through valve V3 based on the stage of bioprocessing.

Sensor 263 coupled to container 218 can provide feedback to system controller 930 with respect to various other process parameters associated with the fluid mixing system 200. The system controller 930 can access foam layer measurements provided by sensor 263 to determine if foam-out has occurred in fluid mixing system 200. The system controller 930 can access cell density measurements provided by sensor 263 to determine if the cell density of fluid has reached a desired value. Further, the system controller 930 can access Raman or Mass spectroscopic measurements provided by sensor 263 to identify the composition of fluids in container 218.

A user operating the user workstation 950 through a graphical user interface 952 is equipped to control operations of equipment of fluid mixing system 910 through components of the system controller 930. Users can also gather data sets related to the fluid mixing system 910 to prepare reports and data useful for scaleup operations.

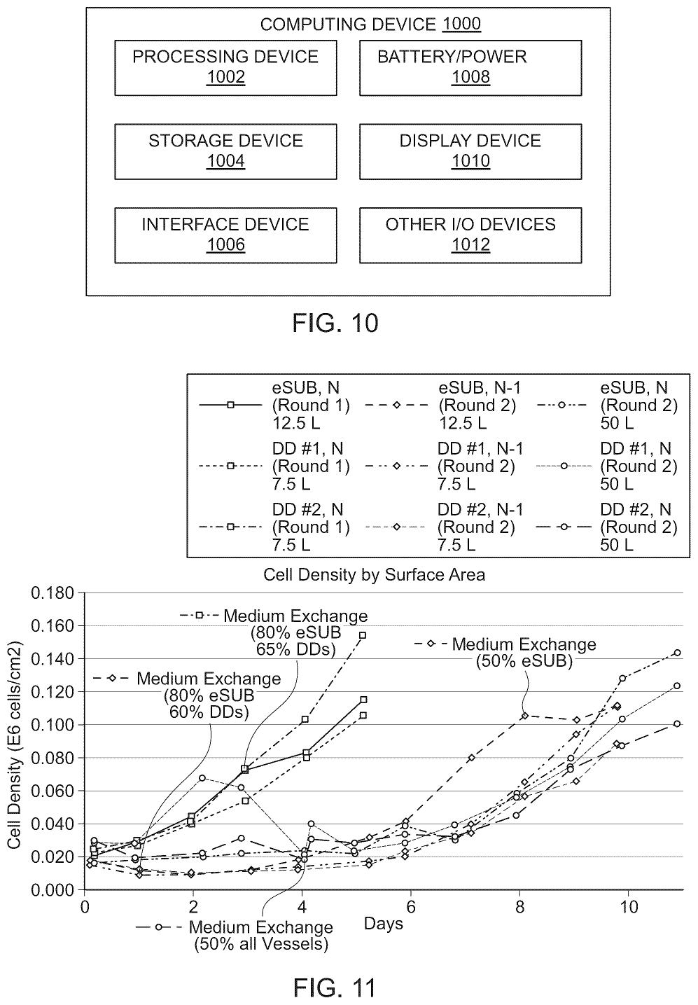

FIG. 10 depicts a block diagram of an example computing device 1000 that can perform some or all operations of an automated bioprocessing system, including a fluid mixing system, user computing device(s), processing unit(s) and/or controller(s) in accordance with the example embodiments. The example automated bioprocessing system, including a fluid processing system, and system controller, including controllers, modules, libraries, and data repositories, disclosed herein can include or be implemented by one or more computing devices. In some embodiments, the example user computing device or workstation 950, and system controller 930 include a single computing device 1000 or multiple computing devices 1000. Further, as discussed below, a computing device 1000 (or multiple computing devices 1000) that implements the example automated bioprocessing system, including a fluid processing system, modules, data repositories, and libraries, can be part of one or more fluid mixing assemblies 914, user or client computing devices 950 with user interfaces 952, processors 932 and controllers 930, a user's local computing device, a service provider's local computing device, or a remote computing device. Client computing devices or user workstations 950, processing units 932, and controllers 930, can also be contained in a unitary computing system or server with a user interface or distributed over servers and systems.

The computing device 1000 of FIG. 10 is illustrated as having a number of components, but any one or more of these components may be omitted or duplicated, as suitable for the application and setting. In some embodiments, some or all of the components included in the computing device 1000 can be attached to one or more motherboards and enclosed in a housing (e.g., including plastic, metal, and/or other materials). In some embodiments, some of these components may be fabricated onto a single system-on-a-chip (SoC) (e.g., an SoC may include one or more processing devices 1002 and one or more storage devices 1004). Additionally, in various embodiments, the computing device 1000 may not include one or more of the components illustrated in FIG. 10, but may include interface circuitry (not shown) for coupling to one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 1000 may not include a display device 1010, but may include display device interface circuitry (e.g., a connector and driver circuitry) to which a display device 1010 may be coupled.

The computing device 1000 can include a processing medium or device 1002 (e.g., one or more processing devices). As used herein, the term “processing device” refer to any device or portion of a device that processes electronic data from registers and/or memory to transform that electronic data into other electronic data that may be stored in registers and/or memory. The processing device 1002 can include one or more digital signal processors (DSPs), application-specific integrated circuits (ASICs), central processing units (CPUs), graphics processing units (GPUs), crypto processors (specialized processors that execute cryptographic algorithms within hardware), server processors, or any other suitable processing devices.

The computing device 1000 can also include a storage device 1004 (e.g., one or more storage devices). The storage device 1004 can include one or more memory devices such as random-access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 1004 can include memory that shares a die with a processing device 1002. In such an embodiment, the memory can be used as cache memory and can include embedded dynamic random-access memory (eDRAM) or spin transfer torque magnetic random-access memory (STT-MRAM), for example. In some embodiments, the storage device 1004 can include non-transitory computer-readable media having instructions thereon that, when executed by one or more processing devices (e.g., the processing device 1002), cause the computing device 1000 to perform any appropriate ones of or portions of the methods and operations disclosed herein.

The computing device 1000 can include an interface device 1006 (e.g., one or more interface devices 1006). The interface device 1006 can include one or more communication chips, connectors, and/or other hardware and software to govern communications between the computing device 1000 and other computing devices. For example, the interface device 1006 can include circuitry for managing wireless communications for the transfer of data to and from the computing device 1000. The term “wireless” and its derivatives are used to describe circuits, devices, systems, methods, techniques, communications channels, etc., that can communicate data through the use of modulated electromagnetic radiation through a nonsolid medium. The term does not imply that the associated devices do not contain any wires, although in some embodiments they might not. Circuitry included in the interface device 1006 for managing wireless communications can implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). In some embodiments, circuitry included in the interface device 1006 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 1006 for managing wireless communications can operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 1006 for managing wireless communications can operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 1006 can include one or more antennas (e.g., one or more antenna arrays) to receipt and/or transmission of wireless communications.

In some embodiments, the interface device 1006 can include circuitry for managing wired communications, such as electrical, optical, or any other suitable communication protocols. For example, the interface device 1006 can include circuitry to support communications in accordance with Ethernet technologies. In some embodiments, the interface device 1006 can support both wireless and wired communication, and/or may support multiple wired communication protocols and/or multiple wireless communication protocols. For example, a first set of circuitries of the interface device 1006 can be dedicated to shorter-range wireless communications such as Wi-Fi or Bluetooth, and a second set of circuitries of the interface device 1006 can be dedicated to longer-range wireless communications such as global positioning system (GPS), EDGE, GPRS, CDMA, WiMAX, LTE, EV-DO, or others. In some embodiments, a first set of circuitries of the interface device 1006 can be dedicated to wireless communications, and a second set of circuitries of the interface device 1006 can be dedicated to wired communications.

The computing device 1000 can include battery/power circuitry 1008. The battery/power circuitry 1008 can include one or more energy storage devices (e.g., batteries or capacitors) and/or circuitry for coupling components of the computing device 1000 to an energy source separate from the computing device 1000 (e.g., AC line power).

The computing device 1000 can include a display device 1010 (e.g., multiple display devices). The display device 1010 can include any visual indicators, such as a heads-up display, a computer monitor, a projector, a touchscreen display, a liquid crystal display (LCD), a light-emitting diode display, or a flat panel display.

The computing device 1000 can include other input/output (I/O) devices 1012. The other I/O devices 1012 can include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 1000, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 1000 can have any suitable form factor for its application and setting, such as a handheld or mobile computing device (e.g., a cell phone, a smartphone, a mobile internet device, a tablet computer, a laptop computer, a netbook computer, an Ultrabook computer, a personal digital assistant (PDA), an ultra-mobile personal computer, etc.), a desktop computing device, or a server computing device or other networked computing components.

### Example Testing 1—Low Volume Cultures Seeded From Cell Factories

Cell culture tests are performed to evaluate the performance of the turbine impeller 300 in maintaining cell growth at low working volumes. A prototype 50 L DynaDrive single-use bioreactor (SUB) as shown in Mixing system 200 is prepared for the tests. The prototype bioprocess container (BPC) has the following deviations from the current standard DynaDrive SUB: (i) The flexible drivetrain is centered in the BPC; (ii) The bottom sweep impeller is replaced with the turbine impeller 300 described in the present document; (iii) A mechanical pump seal or cap 400 is integrated into the turbine impeller 300 to isolate the bottom bearing from the process fluid; (iv) A ⅜″ tube port and length of ⅜″ elastomeric tubing is added to the bottom right corner of the front face of the BPC 218 for decanting steps. A second prototype DynaDrive BPC is also prepared with the same deviations identified above, except a flat blade-style impeller is used to replace the standard bottom sweep impeller of the drivetrain instead of the turbine geometry.

Vero cells is cultured on microcarriers in the prototype DynaDrive BPCs. Another Vero cell culture is grown in parallel in a 50 L HyPerforma Single Use Bioreactor (SUB) for microcarriers to serve as a baseline for expected cell growth. Bioprocess parameters for the cultures is as follows: Microcarrier Type Cytodex 1; Microcarrier Concentration 3 g/L; Cell Type Vero; Culture Medium VP SFM; Cell Seed Density 0.019×106 cells/cm2; Working

Volume(s) DynaDrive—7.5 L; HyPerforma SUB—12.5 L; Impeller tip speed DynaDrive—0.23 m/s; HyPerforma SUB—0.34 m/s. Cells used to seed the single-use bioreactors were harvested from 10-layer cell factories using TrypLE Express. Cell density (determined by crystal violet-stained nuclei on hemocytometer), metabolite concentrations (e.g., Glucose, L-glutamine, Lactate), and Lactate Dehydrogenase (LDH) concentration are the metrics used to compare cultures. The bioreactors are operated for five days, and culture metrics are collected daily. A complete medium exchange is performed on day 3 for all vessels. A plot of cell densities against the number of days is shown in FIG. 11 (data shown by blue lines with square data markers) where DD #1 indicates the DynaDrive with the flat blade-style impeller and DD #2 indicates the DynaDrive with the turbine impeller. Upon reaching the final day of growth, cell density is approximately 34% higher in the DynaDrive with the turbine impeller than in the Hyperforma SUB, and is approximately 9% lower in the DynaDrive with the flat blade-style impeller compared to the Hyperforma SUB.

### Example Testing 2—Low Volume Cultures Seeded From Microcarrier Culture. Scaled Up to 50 L

Cell culture application testing described in Example testing 1 is repeated but with the following changes: (1) Vero cells is used to initially seed the bioreactors at low volume (7.5 L in DynaDrives, 12.5 L in Hyperforma SUB) are harvested from microcarriers in a 6 L glass bioreactor. (2) The SUBs are passaged to full working volume (50 L) after the cells reached confluency on the microcarriers at the low working volumes. Example steps for passaging the SUBs at low volume to full volume are outlined in Example 3. (3) A complete medium exchange was performed in all the low-volume cultures on Day 1. (4) A 50% medium exchange is performed in the Hyperforma SUB at low volume on Day 8 and in all full-volume cultures on Day 4.

Cell densities versus days of culture are plotted in FIG. 11 (low-volume data shown by lines with diamond data markers; full-volume data show by lines with circle data markers). On the final day of growth in the low-volume cultures, cell density is approximately 20% lower in the DynaDrive with the turbine impeller than in the Hyperforma SUB, and it is approximately equal in the DynaDrive with the flat blade-style impeller compared to the Hyperforma SUB. On the final day of growth in the full-volume cultures, cell density is approximately 30% lower in the DynaDrive with the turbine impeller than in the Hyperforma SUB, and it is approximately 14% lower in the DynaDrive with the flat blade-style impeller compared to the Hyperforma SUB.

### Example Testing 3—Microcarrier Passaging Procedure in Bioreactors

Below listed are scale-up (i.e., passaging) steps involved in a typical cell cultivation process carried out in Mixing Systems 200, 800, including mixing apparatus or impeller 232, 300, 887: (1) Initially samples are collected of fluid 201 to count cells/measure other metrics (metabolite and chemistry data, Lactate Dehydrogenase, Osmolarity, pictures); (2) Immediately after sampling, agitation and gassing is paused to let microcarriers settle; (3) 50 L Labtainer is coupled or welded to DynaDrives and Hyperforma SUB to decant lines; (4) Probe belt of bags are tapped to dislodge microcarriers settled on probes and in ports. The time to settle for microcarriers is around 15 min; (5) Fluid or Medium supernatant is decanted into labtainers (˜7 L in DDs and ˜12 L in Hyperforma SUB for cultures initially at low working volume); (6) 20 L labtainer containing saline is welded or coupled onto all SUBs; (7) After decanting, approximately 10 L Saline is added into all SUBs. Microcarriers are gently agitated to resuspend and rinse microcarriers for 2 min (Time to decant medium and rinse with Saline —15 min); (8) Agitation is paused and microcarriers are allowed to settle; (9) Steps 4 through 8 are repeated; (10) Saline from the second wash is decanted; (11) 5 L labtainer containing TrypLE Express is welded or coupled to each SUB; (12) Agitation is resumed and cells are allowed to detach from microcarriers (Approx—1 hour) with continuous monitoring to gauge cell detachment under the microscope; (13) Labtainer containing Soybean Trypsin Inhibitor is welded or coupled to each SUB and added to vessels to quench trypsin enzyme. (14) Weld container of fresh microcarriers to the vessel. Add microcarriers to the vessel; (15) Container including fresh VP SFM is welded to the vessel; fresh medium is added to vessel to a predetermined volume. (16) Gassing is resumed with controls for pH (7.3 setpoint), Dissolved Oxygen (DO) (30% setpoint, Air at 0.0-0.25 lpm), and agitation (Low to medium with intermittent mixing steps); (17) After about 4 hours, samples are retrieved to get initial culture metrics.

The different embodiments and examples of the fluid mixing systems and methods described herein provide several advantages over known solutions for mixing in bioprocessing equipment. For example, illustrative embodiments and examples described herein allow for the least shear agitation of fluids, especially in cases where the fluid includes shear-sensitive cell lines.

Additionally, and among other benefits, illustrative embodiments and examples described herein allow for increasing efficient mixing at the proliferation step of the cell culture process.

Additionally, and among other benefits, illustrative embodiments and examples described herein prevent the aggregation of cells, thereby increasing cell harvest yields.

Additionally, and among other benefits, illustrative embodiments and examples described herein are configured to provide a complete, single-use solution for mixing fluids in upstream bioprocessing of recombinant proteins such as monoclonal antibodies and viral vector production.

Additionally, and among other benefits, illustrative embodiments and examples described herein allow for using one or more turbine impellers to enhance the mixing of fluids in bioprocessing equipment.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems, processes, and/or products according to certain embodiments of the present disclosure may include, incorporate, or otherwise comprise properties features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting the application or inclusion of said features to the specific embodiment. Rather, it will be appreciated that other embodiments can also include said features without necessarily departing from the scope of the present disclosure.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

1.-7. (canceled)

8. A fluid mixing system comprising:
a container having a first end, an opposing second end, and an interior surface bounding a compartment;
a first impeller disposed inside the compartment and coupled rotationally to the first end or the second end of the container, the first impeller being configured to receive a fluid in an axial direction into an interior space of the first impeller and distribute the fluid radially towards the interior surface of the container upon rotation of the impeller.

9. The fluid mixing system as recited in claim 8, further comprising an elongated member coupled between the first end of the container and the first impeller.

10. The fluid mixing system as recited in claim 9, wherein the elongated member is a drive shaft.

11. The fluid mixing system as recited in claim 9, further comprising a second impeller coupled to the elongated member.

12. The fluid mixing system as recited in claim 11, wherein the second impeller is spaced apart from the first impeller.

13. The fluid mixing system as recited in claim 8, wherein the first impeller comprises:
a hub having a top portion and a bottom portion, a central opening extending between the top and bottom portions along a centerline;
a base flange extending outward from the bottom portion of the hub; and
a plurality of blades coupled to the hub, and extending to a shroud wall surrounding the top portion of the hub.

14. The fluid mixing system as recited in claim 13, wherein the plurality of blades comprises at least two blades.

15. The fluid mixing system as recited in claim 13, wherein the plurality of blades comprises six blades.

16. The fluid mixing system as recited in claim 8, further comprising a flexible drive line coupled between the first end of the container and a top portion of the first impeller, and a bottom portion of the first impeller being coupled to the second end of the container.

17. The fluid mixing system as recited in claim 16, wherein the flexible drive line comprises a single continuous driveline.

18. The fluid mixing system as recited in claim 16, wherein the flexible drive line comprises a first drive line spaced apart from a second drive line.

19. The fluid mixing system as recited in claim 18, wherein the first drive line is spaced apart from the second drive line by a plurality of rungs.

20. The fluid mixing system as recited in claim 8, wherein the impeller has a turbine shape.

21. The fluid mixing system as recited in claim 8, wherein the fluid comprises microcarriers and cells and the first impeller is configured to stir the fluid to provide a homogenous suspension of the microcarriers and cells.

22. The fluid mixing system as recited in claim 21, wherein the container has a volume of 50 L and the first impeller is rotated at an rpm ranging between 30-40 rpm in a working volume of 7.5 L of the fluid.

23. The fluid mixing system as recited in claim 8, wherein the container has a volume of 7.5 L, 12.5 L, 50 L, or 500 L.

24. The fluid mixing system as recited in claim 8, wherein the fluid comprises microcarriers and cells and the first impeller is configured to minimize damage to the cells.

25. The fluid mixing system, as recited in claim 21, wherein the impeller is configured to avoid formation of one or more stagnation zones in the fluid.

26. A method for mixing a fluid, the method comprising:
inserting a container assembly into a chamber of a support housing, the container assembly comprising:
a container having a first end, an opposing second end, and an interior surface bounding a compartment;
a first impeller disposed within the compartment of the container and coupled rotationally to the first end or the second end of the container, wherein the first impeller is configured to receive the fluid in an axial direction into an interior space of the first impeller and distribute the fluid radially towards the interior surface of the compartment; and
rotating the first impeller within the container to mix the fluid.

27. The method as recited in claim 26, wherein the first impeller comprises:
a hub having a top portion and a bottom portion, a central opening extending between the top and bottom portions along a centerline;
a base flange extending outward from the bottom portion of the hub; and
a plurality of blades coupled to the hub, and extending to a shroud wall surrounding the top portion of the hub.

28.-44. (canceled)
